(19) United States
(12) Patent Application Publication
(10) Pub. No.: US 2009/0145355 A1
(43) Pub. Date: Jun. 11, 2009

(54) APPARATUS FOR TREATING PARTICLES

(76) Inventors: Jay R. Garner, Clute, TX (US); Paul R. Meiller, Lake Jackson, TX (US); Dominick A. Burlone, Rio Rancho, NM (US); R. Merritt Sink, Charlotte, NC (US); Judy Easterling, Angleton, TX (US)

Correspondence Address: CONNOLLY BOVE LODGE & HUTZ, LLP, P O BOX 2207, WILMINGTON, DE, 19899, US

(21) Appl. No.: 12/207,884

(22) Filed: Sep. 10, 2008

Related U.S. Application Data
(63) Continuation of application No. 11/276,698, filed on Mar. 10, 2006.
Application No. 11/276,698 is a continuation of application No. PCT/EP2007/051997, filed on Mar. 2, 2007.

(51) Int. Cl. B05C 5/00

(52) U.S. Cl. 118/303

(57) ABSTRACT

An apparatus for treating a plurality of particles, such as ammonium sulfate, with a coating, such as a wax, to prevent caking of the particles. The apparatus includes a feed chute, a diffuser and an exit chute. An applicator is mounted adjacent a base of the diffuser for spraying the coating downwardly away from the diffuser into a predefined pattern. The exit chute includes a deflector for intersecting a curtain of particles falling from the diffuser and for redirecting the particles into the predefined pattern of the coating. A heating element is mounted to the deflector for maintaining a predetermined temperature of the deflector thereby preventing accumulation of the coating on the deflector.

### PRIORITY

Priority is claimed as a continuation application to PCT/EP2007/051997, filed Mar. 2, 2007, which claims benefit of U.S. patent application Ser. No. 11/276,698, filed Mar. 10, 2006.

### BACKGROUND OF THE INVENTION

1. Field of the Invention

The subject invention relates to an apparatus for treating particles, such as treating ammonium sulfate granules with an anticaking agent.

2. Description of Related Art

The prior art is replete with various methods of applying coatings, typically in a liquid form, to solid particles. Many of these prior art systems use a horizontally rotational chamber or drum where a stream of a liquid coating is applied as the particles roll within the drum. Examples of these drum type systems are disclosed in U.S. Pat. Nos. 5,443,637 and 5,501,874. These drum systems require large amounts of space and energy to operate. Also, these systems can be expensive to construct, maintain and install. Other prior art systems utilize other rotational parts for applying the coating, which can likewise be expensive and are also prone to failure. For example, U.S. Pat. Nos. 4,596,206 and 2,862,511 utilize rotary applicators for applying a liquid coating. As other examples, U.S. Pat. No. 4,275,682 utilizes rotating conical plates for dispersing the liquid coating and U.S. Pat. No. 4,520,754 discloses a device that applies an electrical charge to the particles, which are then coated by a rotational applicator with the coating containing an opposite charge.

In order to avoid the pitfalls with the above designs, the prior art has developed alternative systems, such as shown in U.S. Pat. No. 5,993,903, which minimize the number of moving parts. The '903 patent discloses a device having a number converging and diverging conical cones with a number of spray applicators disposed along a length thereof. The '903 patent, however, does not optimize a throughput of the number of particles passing through the device with an amount of coating being sprayed. In other words, the '903 patent fails to provide an optimum throughput of particles relative to the amount of coating being sprayed to achieve a desired percentage of particles covered. The '903 patent simply sprays the particles at each intersection of the converging and diverging cones without any efforts to optimize the efficiency of the coating process.

In addition, the prior art does not address the issue of the coating sticking to the components of the system itself. In other words, during operation, the coating can become caked onto various components of the system, thereby reducing the effectiveness of the system.

Accordingly, there remains a need to develop a device with a minimal number of moving parts that efficiently treats a relatively large throughput of particles while avoiding the deficiencies associated with the coating caking onto various components.

### SUMMARY OF THE INVENTION AND ADVANTAGES

An apparatus for treating a plurality of particles with a coating. The apparatus comprises a feed chute having an inlet for receiving the particles and an outlet for discharging the particles. A diffuser is disposed adjacent the feed chute with the diffuser having an angled wall and a base for intersecting the particles discharged from the outlet and for creating a curtain of particles about the diffuser. An applicator is mounted adjacent the base of the diffuser for spraying the coating downwardly away from the diffuser into a predefined pattern. An exit chute is disposed about the diffuser for capturing the curtain of particles with the exit chute including a deflector for intersecting the curtain of particles and redirecting the particles into the predefined pattern of the coating. A heating element is mounted to the deflector for maintaining a predetermined temperature of the deflector thereby preventing accumulation of the coating on the deflector.

Accordingly, the subject invention provides an apparatus for efficiently treating a large amount of particles with a minimal amount of coating and for ensuring that the coating does not become caked on certain components of the apparatus.

### BRIEF DESCRIPTION OF THE DRAWINGS

Other advantages of the present invention will be readily appreciated as the same becomes better understood by reference to the following detailed description when considered in connection with the accompanying drawings wherein.

FIG. 1 is a partial fragmentary side view of an apparatus incorporating the subject invention;

FIG. 2 is a partial fragmentary end view of the apparatus;

FIG. 3 is a perspective view of a diffuser within a diffuser housing;

FIG. 4 is a partial fragmentary perspective view of a sub-assembly of the apparatus schematically illustrating a feed chute, the diffuser, an applicator, and an exit chute;

FIG. 5 is a partially cross-sectional schematic view of the sub-assembly with a single particle passing therethrough;

FIG. 6 is another partially cross-sectional schematic view of the sub-assembly with a plurality of particles passing therethrough; and

FIG. 7 is a partially cross-sectional schematic view of an alternative sub-assembly of the apparatus having an outer chamber, the diffuser, the applicator, and a deflector.

### DETAILED DESCRIPTION OF THE INVENTION

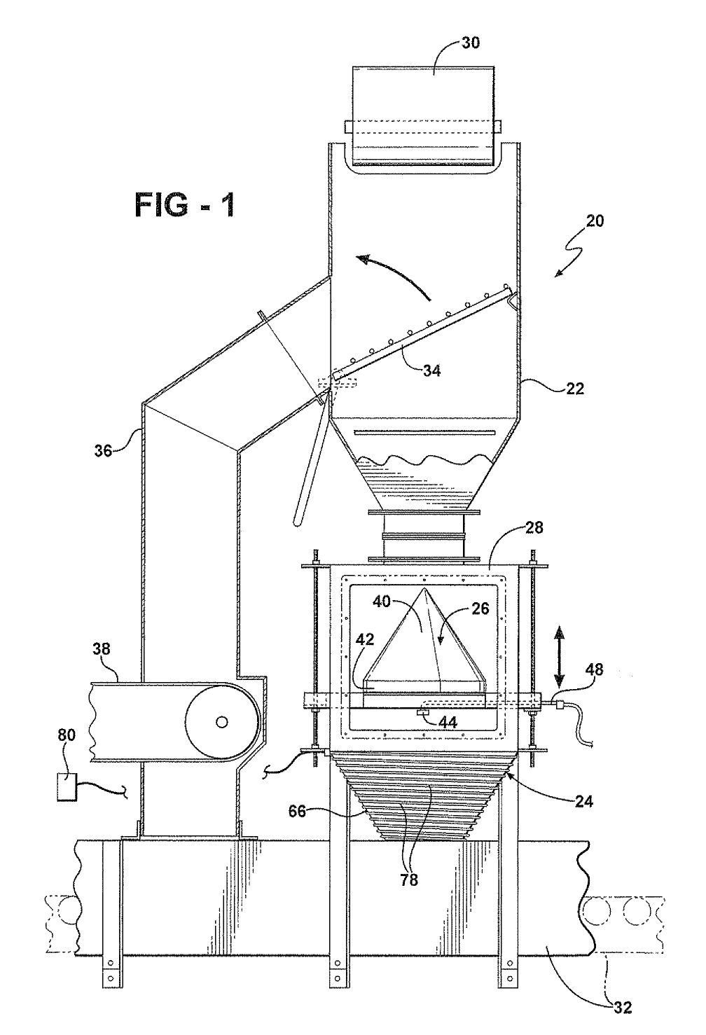

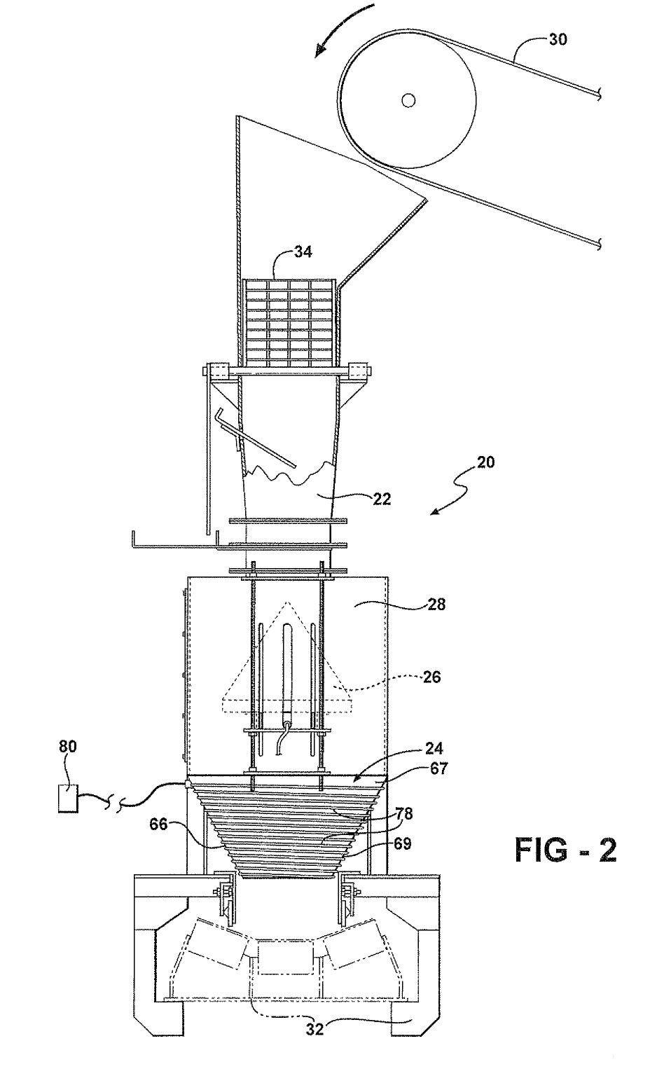

Referring to the Figures, wherein like numerals indicate like or corresponding parts throughout the several views, an apparatus in accordance with the subject invention is generally shown at 20 in FIGS. 1 and 2. The apparatus 20 includes a feed chute 22 and an exit chute 24. The feed chute 22 has an inlet for receiving particles and an outlet for discharging the particles (the particles are not shown in this Figure). The feed chute 22 is preferably configured as a hopper having angled walls at an inlet thereof. The exit chute 24 is discussed in greater detail below. A diffuser 26 and a diffuser housing 28, which are discussed in greater detail below, are disposed between the feed 22 and exit 24 chutes. A feed conveyor 30 is preferably disposed over the feed chute 22 to provide a desired inflow of particles. An exit conveyor 32 is preferably disposed below the exit chute 24 to capture and transport treated particles as the particles are discharged from the apparatus 20. The feed chute 22, exit chute 24, and conveyors 30, 32 are know to those skilled in the art and may be of any suitable design or configuration.

A screen 34 is mounted within the feed chute 22 for sifting the plurality of particles before the particles intersect the diffuser 26. The screen 34 has a plurality of openings of a predetermined size wherein any particles larger than this predetermined size cannot pass through the screen 34. It should be appreciated that the openings may be of any suitable size or configuration. In one contemplated embodiment, the size of each of the openings is one square inch. Preferably, the size of the openings is based on the size of a gap between the feed chute 22 and the diffuser 26. The screen 34 is therefore provided to prevent clogging of the particles between the feed chute 22 and the diffuser 26. As shown in FIG. 1, a bypass chute 36 is mounted to the feed chute 22 and is aligned with the screen 34 such that any particles larger than the predetermined size (as defined by the screen 34) are redirected into the bypass chute 36. A bypass conveyor 38 collects the particles larger than the predetermined size as the particles are discharged from the bypass chute 36.

Turning to FIGS. 1-3, the diffuser 26 and diffuser housing 28 are shown in greater detail. The diffuser housing 28 supports the diffuser 26 adjacent the feed chute 22. The diffuser 26 includes an angled wall 40 and a base 42 to define a substantially cone shaped configuration. It should be appreciated that the diffuser 26 may be of any suitable configuration as is needed.

As shown in FIG. 1 an applicator 44, or spray nozzle, is mounted adjacent to the base 42 of the diffuser 26. The applicator 44 is preferably mounted centrally under the diffuser 26 to reduce the likelihood of damage or clogging from the particles. An inlet pipe 48 is connected to the applicator 44 to provide the requisite coating material to the applicator 44. As discussed in greater detail below, the applicator 44 sprays a coating downwardly away from the diffuser 26. Applicators 44 that are suitable for the subject invention are well known in the art and will therefore not be discussed in any greater detail.

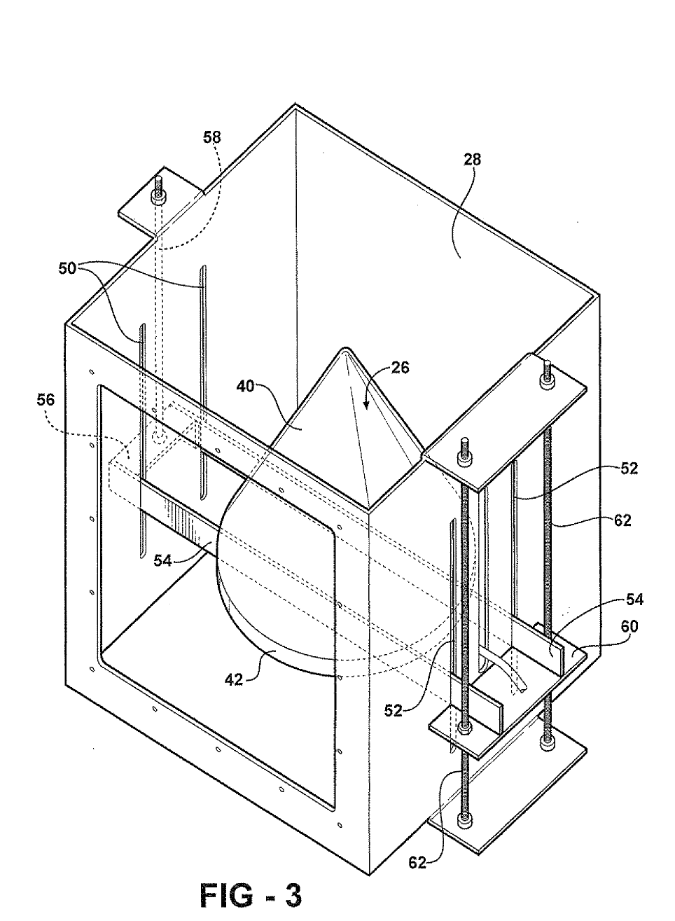

As best shown in FIG. 3, the diffuser housing 28 includes four walls forming a substantially box shaped structure with one of the walls having a window disposed therein. A first pair of slots 50 is formed in one of the walls and a second pair of slots 52 is formed in an opposing wall aligned with the first pair of slots 50. A pair of rails 54 extend across the diffuser housing 28 with each first end exiting out of corresponding first slots 50 and each second end exiting out of corresponding second slots 52. The first ends of the rails 54 are interconnected by a bracket 56. A first threaded shaft 58 interconnects the bracket 56 to the diffuser housing 28. The second ends of the rails 54 are mounted to a plate 60. Preferably a pair of second threaded shafts 62 interconnect the plate 60 to the diffuser housing 28. The diffuser 26 is mounted to the rails 54 to mount the diffuser 26 to the diffuser housing 28. The rails 54, bracket 56, plate 60, and threaded shafts 58, 62 provide an adjustment mechanism coupled between the diffuser housing 28 and the diffuser 26 for adjusting a height of the diffuser 26 relative to the diffuser housing 28. Further, the adjustment mechanism adjusts a height of the diffuser 26 relative to the feed chute 22 to define a desired gap between the diffuser 26 and feed chute 22. Preferably, the height of the diffuser 26 is secured relative to the feed chute 22 prior to the operation of the apparatus 20.

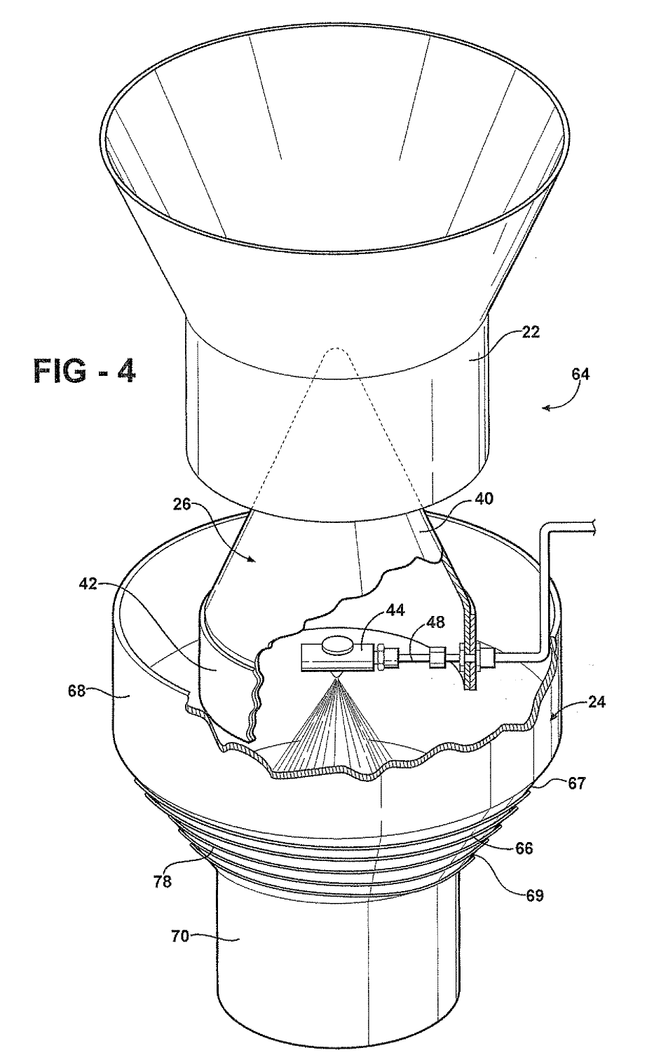

As also shown in FIGS. 4-6, a sub-assembly of the apparatus 20 is schematically shown at 64. The sub-assembly 64 includes the feed chute 22, diffuser 26, applicator 44, and exit chute 24. In order to best illustrate some of the operational features of the invention, many of the mounting components are removed in these Figures such that this sub-assembly 64 is somewhat schematic in detail. In FIGS. 4-6, the applicator 44 is mounted to the base 42 of the diffuser 26 through the inlet pipe 48.

As best shown in FIGS. 1-2 and 4-7, the exit chute 24 is disposed about the diffuser 26. As with the feed chute 22, the exit chute 24 is preferably configured as hopper having angled walls at an inlet thereof. The exit chute 24 includes a deflector 66 disposed below the diffuser 26 and the applicator 44. The deflector 66 includes a top 67 and a bottom 69 with a diameter of the top 67 being wider than a diameter of the bottom 69. Preferably, the deflector 66 angles downwardly from the top 67 to the bottom 69. The deflector 66 is angled in such a manner as to adequately redirect the particles without clogging the exit chute 24 or interfering with the operation of the applicator 44. Even more preferably, the deflector 66 cuts across the base 42 such that an entire curtain of particles falling from the base 42 will be redirected by the deflector 66.

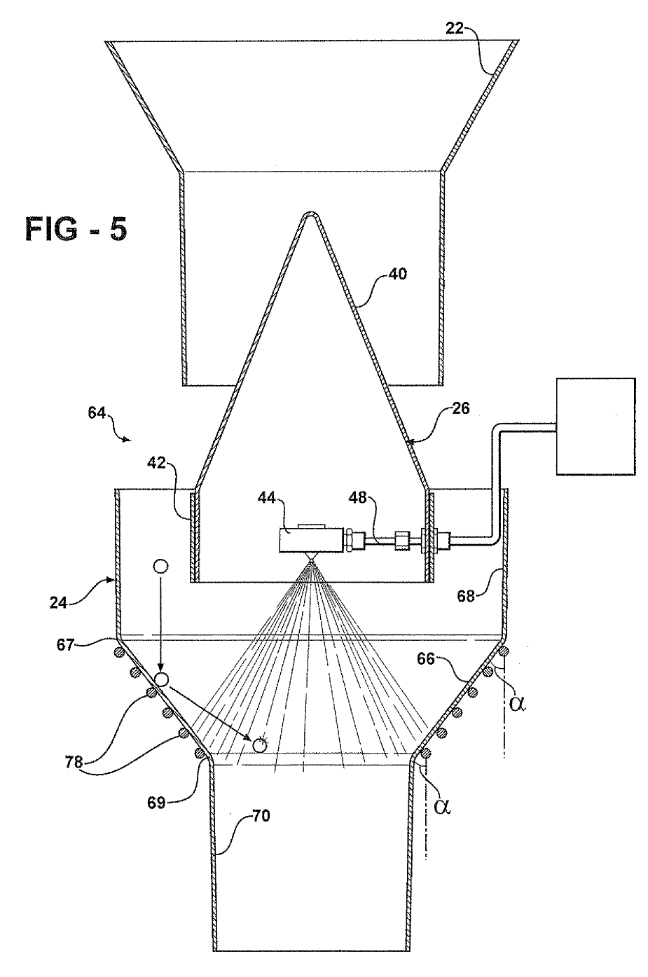

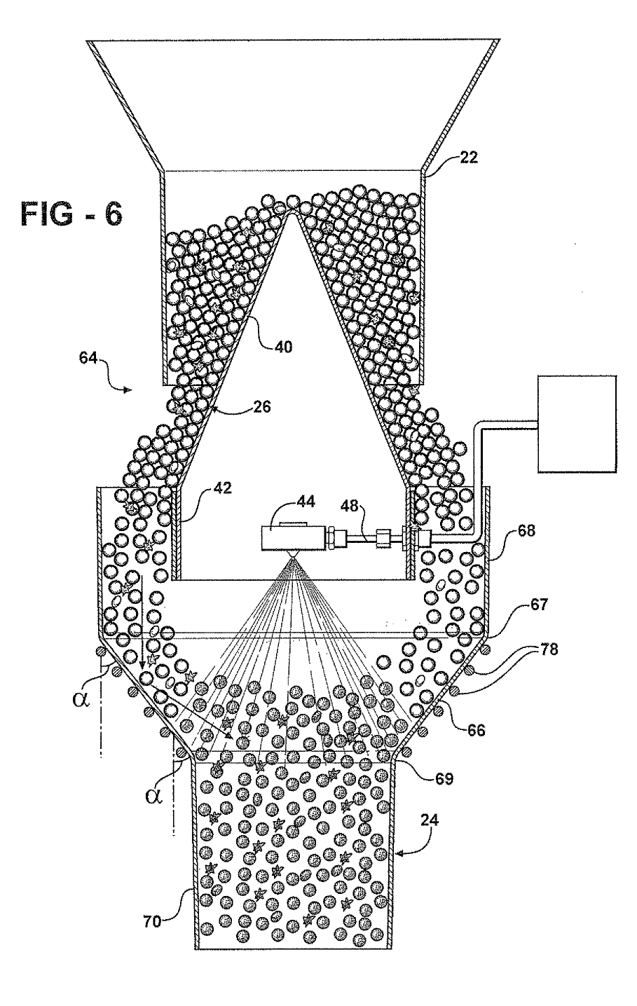

In the embodiment of FIGS. 4-6, the exit chute 24 includes a capture portion 68 and a discharge portion 70 which is smaller in diameter than the capture portion 68. The deflector 66 is angularly positioned between the larger capture portion 68 and the smaller discharge portion 70. Preferably, the capture portion 68 of the exit chute 24 is positioned adjacent the diffuser 26 for positioning the deflector 66 adjacent the base 42. The deflector 66 may alternatively be mounted directly to the diffuser housing 28, such as shown in FIGS. 1 and 2. As best shown in FIGS. 5 and 6, the angle α of the deflector 66 relative to the base 42 of the diffuser 26 or the capture portion 68 of the exit chute 24 may be from 45 to 80 degrees and is preferably 60 degrees.

As best shown in FIGS. 1-2 and 4-7, a heating element 78 is mounted to the deflector 66 for maintaining a predetermined temperature of the deflector, which prevents accumulation of the coating on the deflector 66. The predetermined temperature of the deflector 66 will vary depending on the type and amount of coating being applied. For a typical wax coating, such as a petroleum wax, the predetermined temperature of the deflector 66 will range from 125 to 220 degrees Fahrenheit and is ideally maintained at 180 degrees Fahrenheit. Preferably, the heating element 78 is at least partially coiled about the deflector 66. Even more preferably, the heating element 78 is coiled about the deflector from the top 67 to the bottom 69 of the deflector 66 such that substantially all of the deflector 66 is heated to an elevated temperature. In the most preferred embodiment, the heating element 78 is further defined as a heating cable coiled about the deflector 66. It should be appreciated that the heating element 78 may be of any suitable design or configuration. As schematically shown in FIGS. 1 and 2, a controller 80 is operatively connected to the heating element 78 for ensuring that the predetermined temperature remains relatively constant.

FIG. 5 illustrates a single particle passing through the sub-assembly 64 and FIG. 6 illustrates a plurality of particles passing through the sub-assembly 64. Preferably, the plurality of particles is further defined as a plurality of granules. Even more preferably, the plurality of granules are further defined as a plurality of ammonium sulfate granules, such as the type used in fertilizer applications. The granules can be in the shaped of spheres, ovals or any other suitable configuration.

The particular method steps of treating the plurality of particles with the coating utilizing the apparatus 20 of the preferred embodiment will now be discussed in detail with reference to FIGS. 4-6. Initially, the plurality of particles are fed into the feed chute 22 from the feed conveyor 30. The particles intersect the diffuser 26 discharging from the outlet of the feed chute 22 to create a curtain of particles falling about the diffuser 26. Preferably, the particles intersect the angled wall 40 to create a curtain of particles falling about the base 42. As discussed above, a height of the diffuser 26 can be adjusted relative to the feed chute 22. Preferably, the height of the diffuser 26 is secured relative to the feed chute 22 prior to the step of intersecting the particles with the diffuser 26.

The plurality of particles pass through the feed chute 22 and about the diffuser 26 at a high throughput rate such that the subject invention can efficiently treat a large volume of particles in a relatively short period of time. It should be appreciated that the speed of the material passing through the apparatus 20 can vary depending upon the type of particle and particle size. One non-limiting example includes the throughput of the particles passing through the feed chute 22 and about the diffuser 26 at a rate of 200 to 40,000 lbs per hour. As another non-limiting example, the throughput of the particles can pass through the feed chute 22 and about the diffuser 26 at a rate of 10,000 to 25,000 lbs per hour. The throughput of the particles can be determined by any suitable device or calculation.

The coating is sprayed from the applicator 44 downwardly away from the diffuser 26 toward the deflector 66 of the exit chute 24 in a predetermined pattern. In the embodiment illustrated, the coating is sprayed downwardly in a cone shaped pattern defining an outer periphery of the sprayed coating. It should be appreciated that the coating could be sprayed in alternative patterns so long as the coating is sprayed downwardly toward the deflector 66. The coating may be sprayed downwardly in a hollow cone shaped pattern for spraying a substantial portion of the coating directly toward the deflector 66. Alternatively, the coating may be sprayed downwardly in a solid cone shaped pattern for spraying a portion of the coating directly toward the deflector 66 and spraying another portion of the coating below the deflector 66 into the discharge portion 70 of the exit chute 24. In either case, the outer periphery of the coating will intersect a portion of the deflector 66. As illustrated, the outer periphery of the coating intersects the deflector 66 approximate the width of the base 42 of the diffuser 26. Preferably, the coating is further defined as an anticaking agent. Even more preferably, the coating is petroleum wax that is heated before being sprayed. The heated deflector 66 ensures that the heated wax coating does not cake or otherwise accumulate on the deflector 66, which would reduce the effectiveness of the deflector 66. In addition, maintaining the heated wax coating on the deflector 66 allows the coating on the deflector 66 to be applied to particles intersecting the deflector 66 (discussed below) below the outer periphery of the coating, thereby improving the overall process.

The curtain of particles falling from the base 42 of the diffuser 26 are captured by the exit chute 24 and intersect with the deflector 66 to redirect the particles into the predetermined pattern of the coating for treating each of the particles with the coating. Preferably, the particles intersect with the deflector 66 to redirect the particles into the pattern before any of the particles are treated with the coating. In other words, the particles remain untreated as the curtain of particles fall about the diffuser 26 and are redirected by the deflector 66. Hence, the particles are preferably only treated after the particles change direction into the outer periphery of the sprayed coating. This feature of the invention is perhaps best illustrated in FIG. 10. A portion of the particles will be redirected off of themselves and will typically intersect the deflector 66 more than once. The heated deflector 66 ensures that the wax coating is maintained in a state that continues to promote adequate treatment of the particles as the particles are redirected into the deflector 66.

Due to the spray pattern and the redirection of the particles, the coating can be sprayed in a relatively low throughput rate in comparison to the high throughput rate of particles passing through the apparatus 20. Again, it should be appreciated that the coating may be sprayed at any suitable rate without deviating from the overall scope of the subject invention. In one non-limiting example, the coating can be sprayed at a rate of 15 to 80 lbs per hour, preferably twenty-five lbs per hour. Preferably, at least twenty five percent of the particles intersecting the deflector are treated during the process. Even more preferably, approximately thirty-five to fifty percent of the particles intersecting the deflector are treated. As non-limiting examples, it has been found that less than fifty percent of ammonium sulfate particles need to be covered to prevent anti-caking of these particles. As another non-limiting example, it has been found that nearly one-hundred percent of ammonium nitrate particles need to be covered to prevent anti-caking of these particles. It should be appreciated, that the percent of coverage for the particles is dependent upon the type of particle, size of the particle, atmospheric conditions, as well as a number of other factors. Hence, the percent of coverage can vary greatly without deviating from the overall scope of the subject invention. The subject invention therefore defines an efficient method treating a large amount of particles with a minimal amount of coating while ensuring that the coating does not cake or accumulate on the deflector 66.

The treated particles are then discharged out of the exit chute 24 and accumulate along the exit conveyor 32. As discussed above, particles that exceed a predetermined size will be re-routed down a bypass chute 36 to a bypass conveyor 38.

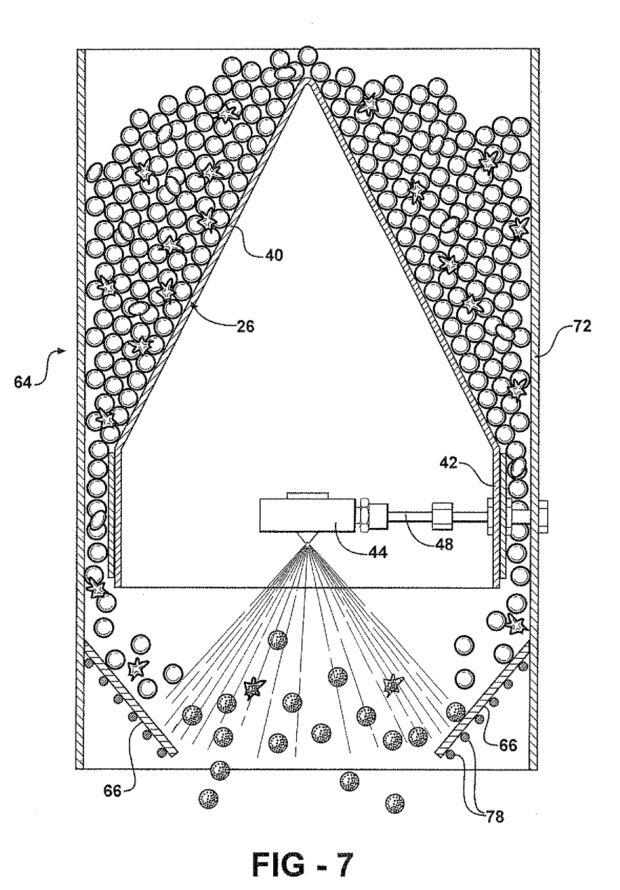

Referring to FIG. 7, an alternative sub-assembly 64 of the apparatus 20 is generally shown. This alternative sub-assembly 64 incorporates a different structure to perform virtually the same efficient treating steps set forth above. In particular, the alternative sub-assembly 64 includes an outer chamber 72, the diffuser 26, the applicator 44, and an alternatively configured deflector 66. The outer chamber 72 can define both the feed chute and the exit chute and can be of any suitable size or configuration. Alternatively, the feed chute and/or exit chute could be separate components mounted to the outer chamber 72. The diffuser 26 and applicator 44 have virtually the same configuration. The deflector 66, however, is an angled wall 66 extending inwardly from the outer chamber 72. A similar heating element 78 is disposed about the angled wall 66 and is preferably coiled about the angled wall 66 for heating the deflector 66.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims the invention may be practiced otherwise than as specifically described.

What is claimed is:

1. An apparatus for treating a plurality of particles with a coating, said apparatus comprising;
a feed chute having an inlet for receiving the particles and an outlet for discharging the particles,
a diffuser disposed adjacent said feed chute with said diffuser having an angled wall and a base for intersecting the particles discharged from said outlet and for creating a curtain of particles about said diffuser,
an applicator mounted adjacent said base of said diffuser for spraying the coating downwardly away from said diffuser into a predefined pattern,
an exit chute disposed about said diffuser for capturing the curtain of particles with said exit chute including a deflector for intersecting the curtain of particles and redirecting the particles into the predefined pattern of the coating, and
a heating element mounted to said deflector for maintaining a predetermined temperature of said deflector thereby preventing accumulation of the coating on said deflector.

2. An apparatus as set forth in claim 1 wherein said heating element is at least partially coiled about said deflector.

3. An apparatus as set forth in claim 1 wherein said deflector includes a top and a bottom with a diameter of said top being wider than a diameter of said bottom, and wherein said heating element is coiled about said deflector from said top to said bottom.

4. An apparatus as set forth in claim 1 wherein said heating element is further defined as a heating cable coiled about said deflector.

5. An apparatus as set forth in claim 1 further including a controller operatively connected to said heating element for ensuring said predetermined temperature remains relatively constant.

6. An apparatus as set forth in claim 1 wherein said heating element maintains said deflector at a temperature ranging from 125 to 220 degrees Fahrenheit.

7. An apparatus as set forth in claim 1 wherein said exit chute is positioned adjacent said diffuser for positioning said deflector adjacent said base.

8. An apparatus as set forth in claim 1 further including a screen mounted within said feed chute for sifting the plurality of particles before the particles intersect the diffuser thereby preventing clogging of the particles between the feed chute and the diffuser

9. An apparatus as set forth in claim 9 further including a bypass chute mounted to said feed chute and aligned with said screen for accepting particles larger than a predetermined size as defined by said screen.

10. An apparatus as set forth in claim 1 wherein said angled wall of said diffuser defines a substantially cone-shaped configuration

11. An apparatus as set forth in claim 10 wherein said applicator is mounted centrally under said cone-shaped diffuser.

12. An apparatus as set forth in claim 1 further including a diffuser housing supporting said diffuser and an adjustment mechanism coupled between said diffuser housing and said diffuser for adjusting a height of said diffuser relative to said diffuser housing.
